(19) United States
(12) Patent Application Publication
(10) Pub. No.: US 2014/0245278 A1
(43) Pub. Date: Aug. 28, 2014

(54) AUTOMOTIVE COMPONENT SELF UPDATE VIA SOFTWARE VERSION CONTROL

(71) Applicant: PANASONIC AUTOMOTIVE SYSTEMS COMPAN OF AMERICA, DIVISION OF PANASONIC CORPOR, (US)

(72) Inventor: JEFFREY M. ZELLEN, Oakland, MI (US)

(73) Assignee: PANASONIC AUTOMOTIVE SYSTEMS COMPANY OF AMERICA, DIVISION OF PANASONIC CORPOR, PEACHTREE CITY, GA (US)

(21) Appl. No.: 13/773,860

(22) Filed: Feb. 22, 2013

(51) Int. Cl. G06F 9/445

(52) U.S. Cl. CPC G06F 8/65; G06F 8/665; G06F 8/71
USPC 717/170

(57) ABSTRACT

A method of updating software files in a motor vehicle includes comparing version identifiers of software files located externally to the vehicle to version identifiers of corresponding software files located within the vehicle. Ones of the software files located within the vehicle that have earlier versions than the corresponding software files located externally to the vehicle are identified. Only the identified ones of the software files located within the vehicle that have earlier versions than the corresponding software files located externally to the vehicle are replaced. The identified ones of the software files located within the vehicle are replaced with the corresponding software files located externally to the vehicle.

### BACKGROUND OF THE INVENTION

1. Field of the Invention

The present invention relates to software file management, and, more particularly, to software file management within an automotive environment.

2. Description of the Related Art

Automotive electronics typically include software that is periodically updated by the manufacturer of the automobile. Current implementations of software updates require either the unit to be removed from the assembly for a firmware update or the utilization of a full file system update. That is, it is known for the hardware that stores the software to be removed from the vehicle for replacement of the memory device that stores the software with another memory device that stores updated software. A problem, however, is that such physical replacement of hardware is labor intensive and removes the vehicle from service while the hardware is being replaced. Alternatively, it is also known for every file of a software program to be updated whenever a new version of any of the files is available. A problem with this approach is that the software storage hardware within the vehicle may experience a high level of wear with frequent and voluminous updates, which may result in early hardware failure and require that the software storage hardware be replaced.

### SUMMARY OF THE INVENTION

The invention may include an electronic automotive component that maintains a list of the versions of the software files stored in the automotive component. The automotive component periodically queries a repository of software files for the latest versions that are available. Only those files that have more recent versions available are copied from the repository to the automotive component.

The invention comprises, in one form thereof, a method of updating software files in a motor vehicle, including comparing version identifiers of software files located externally to the vehicle to version identifiers of corresponding software files located within the vehicle. The software files located within the vehicle that have earlier versions than the corresponding software files located externally to the vehicle are identified. Only the identified ones of the software files located within the vehicle that have earlier versions than the corresponding software files located externally to the vehicle are replaced. The identified earlier version software files located within the vehicle are replaced with the corresponding software files located externally to the vehicle.

The invention comprises, in another form thereof, a method of updating software files in a motor vehicle, including wirelessly transmitting a query from the vehicle. The query requests a list of version identifiers of software files stored in a repository at a location remote from the vehicle. The requested list of the version identifiers of the software files stored in the repository is received at the vehicle. The version identifiers of the software files stored in the repository are compared to version identifiers of corresponding software files located within the vehicle. The software files located within the repository that have more recent versions than the corresponding software files located within the vehicle are identified. Copies of only the identified software files stored in the repository that have more recent versions than the corresponding software files located within the vehicle are requested. The corresponding software files located within the vehicle are replaced with the identified software files stored in the repository.

The invention comprises, in yet another form thereof, a method of updating software files in a motor vehicle, including detecting a portable memory device being inserted into a port of the vehicle. Version identifiers of software files stored in the portable memory device are ascertained. The version identifiers of the software files stored in the portable memory device are compared to version identifiers of corresponding software files located within the vehicle. The software files located within the portable memory device that have more recent versions than the corresponding software files located within the vehicle are identified. Only the identified software files stored in the portable memory device that have more recent versions than the corresponding software files located within the vehicle are copied.

An advantage of the present invention is that it may reduce the total necessary size of the target memory storage that is required during the updating of the files.

Another advantage of the present invention is that it may reduce the wear on the target storage by minimizing the number of file transactions to the target, thereby increasing the life of the storage hardware and reducing warranty returns.

Yet another advantage of the present invention is that it may improve the traceability of software updates on the target storage.

A further advantage of the present invention is that it may provide a flexible source of software to accommodate the next generation of hardware architecture.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram illustrating one embodiment of an automotive software update arrangement of the present invention.

FIG. 2 is a flow chart of one embodiment of an automotive software update method of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

According to the invention, an automotive component may maintain a database of installed software files and versions. Upon request, the component may query the repository for available version information and initiate a transfer of updated information. Upon completion of transfer of the updated files, a post-transfer process may be executed to finalize the update.

The repository can be either a virtual repository server on a removable medium, or a repository server available through a networked interface such as Bluetooth, WiFi or broadband Internet access. In the case of a removable medium, a copy of the software repository may be placed on a removable medium and uploaded by the user to the automotive network to retrieve the virtual repository.

Utilizing a subversion repository enables file-by-file granularity in the software update. That is, only those files that have a newer version than the corresponding file currently stored in the automobile are copied to the automobile.

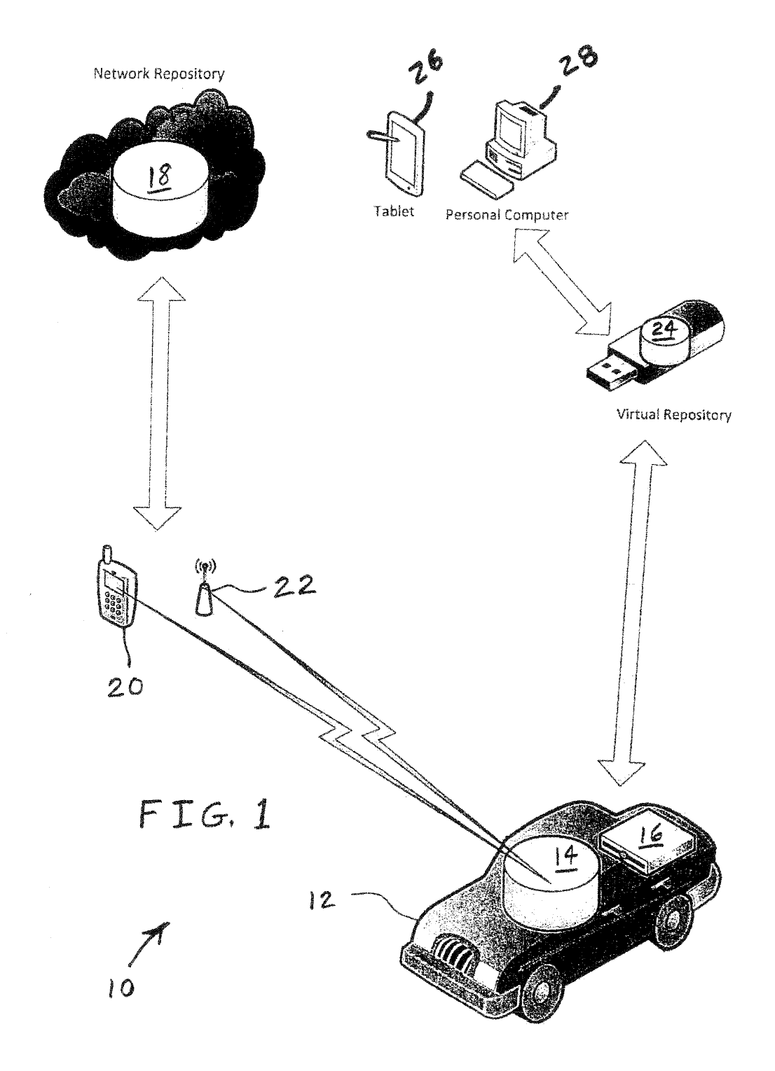

FIG. 1 is a block diagram illustrating one embodiment of an automotive software update arrangement 10 of the present invention. Apparatus 10 may include an automobile 12 having a memory device 14 storing a database of installed software files and versions. In addition to the executable software files and other types of software files, the database may store a file that lists each software file stored therein in association with the version number of the software file. Also within automobile 12 is a hard drive 16 that may include a processor, and which may be in communication with memory device 14.

Automobile 12 may be in communication with a remote network repository 18 which stores the latest versions of the software files stored in memory device 14. For example, automobile 12 may wirelessly communicate with a remote network repository 18 via a cellular communication device 20 disposed within automobile 12, or via an antenna 22 on automobile 12. Thus, updated versions of the software files stored in memory device 14 may be wirelessly transferred from remote network repository 18 to memory device 14. Remote network repository 18 may be operated and maintained by a manufacturer of automobile 12 and at the manufacturer's facilities.

Alternatively, automobile 12 may receive updated files from a virtual repository 24, which may be in the form of a portable memory device, such as a USB memory device storing the latest versions of the software files stored in memory device 14. Automobile 12 may include a USB port (not shown) in communication with hard drive 16 and its associated processor. Thus. USB memory device 24 may be inserted into the USB port such that the updated files may be copied from USB memory device 24 to memory device 14. USB memory device 24 may receive the updated software files from a tablet computer 26 or a personal computer 28. Tablet computer 26 or a personal computer 28 may be operated and maintained by a manufacturer of automobile 12 and at the manufacturer's facilities.

During use, the manufacturer of automobile 12 or some other service personnel may wirelessly contact automobile 12 via cellular communication device 20 or via an antenna 22, and request that automobile 12 updates its stored software files. In response to the request, automobile 12 may transmit a query to network repository 18 which provides a list of the software files that are stored in memory device 14 and that may need to be updated. Network repository 18 may then transmit back to automobile 12 a list of the most recent version numbers of the software files on the list that network repository 18 received from automobile 12. Automobile 12 may then compare the version numbers received from network repository 18 to the version numbers of the software files that are currently stored in memory device 14. As a result of the comparison, automobile 12 may request from network repository 18 the latest version of every file for which automobile 12 does not already have the latest version.

Alternatively, automobile 12 may transmit both a list of the software programs that are stored in memory device 14 and their associated version numbers. Network repository 18 may then perform the comparison of the version numbers of the software programs stored in memory device 14 to the latest version numbers stored in network repository 18. Next, network repository 18 may transmit to automobile 12 only the software files whose latest versions are not already stored in memory device 14.

In the case of a virtual repository in the form of a USB memory device 24, the manufacturer of automobile 12 or some other service personnel may periodically ship USB memory device 24 to a local service garage or directly to the home of the owner of automobile 12. Service personnel or the owner of automobile 12 may insert USB memory device 24 into the USB port of automobile 12. The processor of automobile 12 may look at the version number of the software files on USB memory device 24 and compare the version numbers to the version numbers of the software files already stored in memory device 14. Next, the processor may copy from USB memory device 24 only the software files whose latest versions are not already stored in memory device 14.

USB memory device 24 may include a separate file that includes a list of all the other files stored on USB memory device 24 and their associated version numbers. Thus, the processor of automobile 12 may have easy access to the version numbers of the software files stored on USB memory device 24, which may facilitate the comparison of these version numbers to the version numbers of the software files already stored in memory device 14.

In a specific example embodiment to further illustrate the inventive method, after automobile 12 has received the request to update the software files stored in automobile 12, automobile 12 may transmit a query to network repository 18 to list the following three software files that are stored in memory device 14 and that may need to be updated:

File A
File B
File C

In response to this query, network repository 18 may transmit to automobile 12 the following list of the latest versions of each of the three software files stored within repository 18:

| | |
|---|---|
| File A | version 4 |
| File B | version 15 |
| File C | version 9 |

Upon receiving the above list of the latest versions of each of the three software files available from network repository 18, automobile 12 may compare the latest version numbers of the files available from network repository 18 to the version numbers of the files already stored in memory device 14, as illustrated in the following Table I:

TABLE I

| | Available from | Already Stored | Already Have |
|---|---|---|---|
| | Network Repository | in Vehicle | Latest Version? |
| File A | version 4 | version 3 | No |
| File B | version 15 | version 12 | No |
| File C | version 9 | version 9 | Yes |

Thus, as a result of the above comparisons, automobile 12 may request from network repository 18 version 4 of File A and version 15 of File B. Version 3 of File A and version 12 of File B in memory device 14 may be overwritten. However, because the latest version of File C (i.e., version 9) is already stored in memory device 14, automobile 12 may not request from network repository 18 version 9 of File C.

In another specific example embodiment to further illustrate the inventive method, after service personnel or the owner of automobile 12 has inserted USB memory device 24 into the USB port of automobile 12, automobile 12 may first detect the presence of the connection of USB memory device 24 to the USB port of automobile 12. After detecting the presence of USB memory device 24 in the port, automobile 12 may look at the versions of the files on USB memory device 24 that correspond to the files that are already stored in memory device 14, as illustrated in the following Table II:

TABLE II

| | On USB |
|---|---|
| File A | version 3.3 |
| File B | version 8.0 |
| File C | version 6.2 |
| File D | version 2.4 |

Upon determining the above list of the latest versions of each of the three software files on USB memory device 24, automobile 12 may compare the latest version numbers of the files available on USB memory device 24 to the version numbers of the files already stored in memory device 14, as illustrated in the following Table III:

TABLE III

| | Available on | Already Stored | Already Have |
|---|---|---|---|
| | USB | in Vehicle | Latest Version? |
| File A | version 3.3 | version 3.2 | No |
| File B | version 8.0 | version 8.0 | Yes |
| File C | version 6.2 | version 5.3 | No |
| File D | version 2.4 | version 2.4 | Yes |

Thus, as a result of the above comparisons, automobile 12 may copy from USB memory device 24 version 3.3 of File A and version 6.2 of File C. Version 3.2 of File A and version 5.3 of File C in memory device 14 may be overwritten. However, because the latest versions of File B (i.e., version 8.0) and File D (i.e., version 2.4) are already stored in memory device 14, automobile 12 may not copy from USB memory device 24 version 8.0 of File B or version 2.4 of File D.

Regardless of which of the above methods are used to update the files in the vehicle, a post-transfer process may be executed to finalize the update. In one embodiment, the vehicle maintains a list of version numbers associated with each software file stored in the vehicle. After older versions of the software files stored in the vehicle have been updated, the list of version numbers associated with each software file stored in the vehicle is also updated to reflect the newer versions of the software that have just been received.

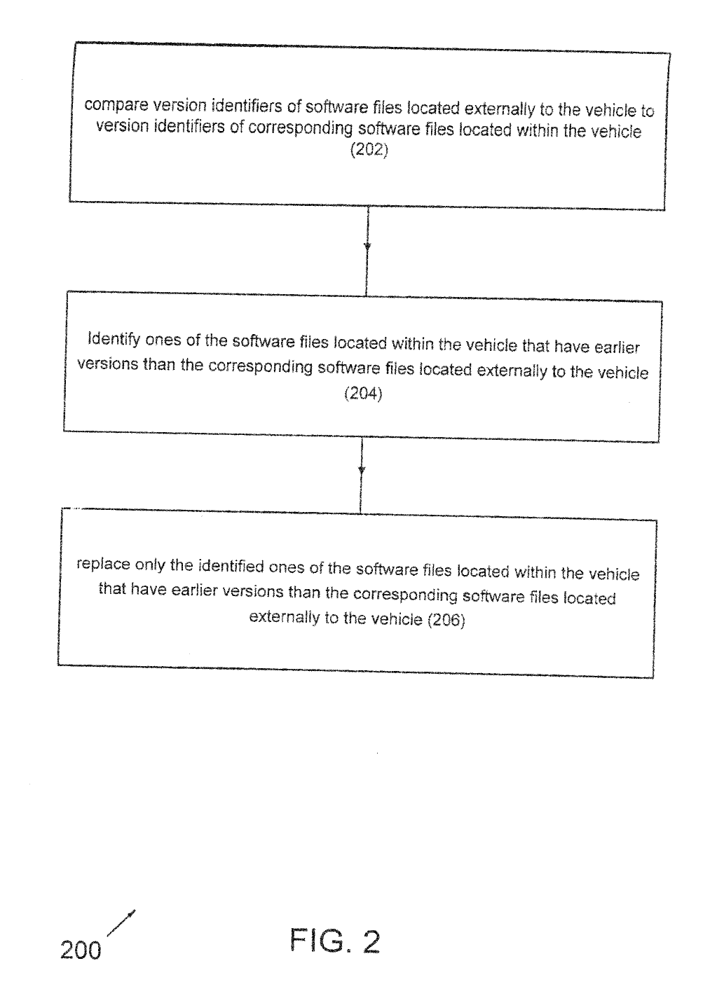

One embodiment of a method 200 of updating software files in a motor vehicle is illustrated in FIG. 2. In a first step 202, version identifiers of software files located externally to the vehicle are compared to version identifiers of corresponding software files located within the vehicle. For example, software files external to the vehicle may be located in a network repository 18 or a USB memory device 24. The vehicle may access the version identifiers of the software files via radio frequency communication, such as by cellular telecommunication and/or via an antenna. Alternatively, a portable memory device, such as a USB memory device, may be inserted into a port in the vehicle such that the software files and their version identifiers may be electronically accessed. The version identifiers may be in some alphanumeric designation. As shown in the tables above, the version identifiers may be designated by numbers, with the later, more recent versions having higher numbers. Alternatively, the version identifiers may be designated by letters, with the designations starting at the letter “A” and later versions being designated by subsequent letters of the alphabet ending in “Z”. For each software file in the vehicle, a processor within the vehicle may compare the version designation in the vehicle to the version designation of the corresponding file (e.g., the file that performs the same function) that is external to the vehicle.

In a next step 204, ones of the software files located within the vehicle that have earlier versions than the corresponding software files located externally to the vehicle are identified. For example, as shown in Table I above. Files A and B are identified as having earlier versions than the corresponding software files located in network repository 18.

In a final step 206, only the identified ones of the software files located within the vehicle that have earlier versions than the corresponding software files located externally to the vehicle are replaced. The identified ones of the software files located within the vehicle are replaced with the corresponding software files located externally to the vehicle. That is, in the example illustrated in Table II, only Files A and B are replaced in the vehicle, with the later versions of Files A and B from network repository 18. File C is not replaced because the latest version is already stored within the vehicle.

Although versions of software are described herein as being identified by a numeric identifier, it is also possible for the versions to be identified by letters.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of updating software files in a motor vehicle, the method comprising the steps of:
comparing version identifiers of software files located externally to the vehicle to version identifiers of corresponding software files located within the vehicle;
identifying ones of the software files located within the vehicle that have earlier versions than the corresponding software files located externally to the vehicle; and
replacing only the identified ones of the software files located within the vehicle that have earlier versions than the corresponding software files located externally to the vehicle, the identified ones of the software files located within the vehicle being replaced with the corresponding software files located externally to the vehicle.

2. The method of claim 1 comprising the further step of requesting that the vehicle update its software files.

3. The method of claim 1 comprising the further step of wirelessly transmitting a query from the vehicle, the query requesting a list of versions of software files stored in a repository at a location remote from the vehicle.

4. The method of claim 3 comprising the further step of receiving at the vehicle the requested list of the versions of the software files stored in the repository.

5. The method of claim 1 wherein the software files located externally to the vehicle are disposed on a portable memory device.

6. The method of claim 1 wherein the corresponding software files located externally to the vehicle are wirelessly received in the vehicle.

7. The method of claim 6 wherein the corresponding software files located externally to the vehicle are wirelessly received in the vehicle via a cellular communication device and/or an antenna.

8. A method of updating software files in a motor vehicle, the method comprising the steps of:
wirelessly transmitting a query from the vehicle, the query requesting a list of version identifiers of software files stored in a repository at a location remote from the vehicle;
receiving at the vehicle the requested list of the version identifiers of the software files stored in the repository;
comparing the version identifiers of the software files stored in the repository to version identifiers of corresponding software files located within the vehicle;
identifying ones of the software files located within the repository that have more recent versions than the corresponding software files located within the vehicle;
requesting copies of only the identified ones of the software files stored in the repository that have more recent versions than the corresponding software files located within the vehicle; and
replacing the corresponding software files located within the vehicle with the identified ones of the software files stored in the repository.

9. The method of claim 8 comprising the further step of requesting that the vehicle update its software files.

10. The method of claim 8 wherein the identified ones of the software files stored in the repository are wirelessly received in the vehicle.

11. The method of claim 10 wherein the identified ones of the software files stored in the repository are wirelessly received in the vehicle via a cellular communication device and/or an antenna.

12. The method of claim 8 wherein the vehicle does not request copies of ones of the software files stored in the repository that have same versions as the corresponding software files located within the vehicle.

13. The method of claim 8 comprising the further step, in response to the replacing step, of updating a list of versions of the software files located within the vehicle.

14. The method of claim 8 wherein the identified ones of the software files stored in the repository are transferred to the vehicle via Bluetooth, WiFi or broadband Internet.

15. A method of updating software files in a motor vehicle, the method comprising the steps of:
detecting a portable memory device being inserted into a port of the vehicle;
ascertaining version identifiers of software files stored in the portable memory device;
comparing the version identifiers of the software files stored in the portable memory device to version identifiers of corresponding software files located within the vehicle;
identifying ones of the software files located within the portable memory device that have more recent versions than the corresponding software files located within the vehicle; and
copying only the identified ones of the software files stored in the portable memory device that have more recent versions than the corresponding software files located within the vehicle.

16. The method of claim 15 wherein the copying step includes overwriting the corresponding software files located within the vehicle with the identified ones of the software files stored in the portable memory device.

17. The method of claim 15 wherein the vehicle does not copy of ones of the software files stored in the portable memory device that have same versions as the corresponding software files located within the vehicle.

18. The method of claim 15 comprising the further step, in response to the replacing step, of updating a list of versions of the software files located within the vehicle.

19. The method of claim 15 wherein the portable memory device comprises a USB memory device.

20. The method of claim 15 wherein the software files are loaded onto the portable memory device by a personal computer or a tablet computer.
